(19) United States
(12) Patent Application Publication
(10) Pub. No.: US 2002/0058191 A1
(43) Pub. Date: May 16, 2002

(54) Toner resin with improved rub-off properties

(76) Inventors: Gordon Edward Hardy JR., Hudson, OH (US); Gary Lee Burroway, Doylestown, OH (US)

Correspondence Address: The Goodyear Tire & Rubber Company, Patent & Tradmark Department - D/823, 1144 East Market Street, Akron, OH, 44316-0001, US

(21) Appl. No.: 09/946,065

(22) Filed: Sep. 4, 2001

Related U.S. Application Data
(60) Provisional application No. 60/234,667, filed on Sep. 22, 2000.

(51) Int. Cl. G03G 9/087

(52) U.S. Cl. 430/108.4; 430/109.31; 526/329.3

(57) ABSTRACT

This invention relates to toner resins that are synthesized by emulsion polymerization which exhibit good electrical charge stability, adhesion to paper, and rub-off characteristics. The toner resins of this invention are comprised of repeat units that are derived from a vinyl aromatic monomer, an acrylic monomer, and acrylonitrile. These resins are void of repeat units that are derived from acrylic acid. The toner resins of this invention also have a number average molecular weight of greater than 12,000, a weight average molecular weight of greater than 36,000, and a glass transition temperature which is within the range of about 45° C. to about 80° C. The toner resins of this invention are typically made by emulsion polymerization utilizing diacid cycloaliphatic emulsifiers to attain improved adhesion to paper, improved electrical charge stability, a high level of resistance to moisture, and resistance to moisture adsorption (adsorbed moisture is known to neutralize electrical charges). This invention more specifically discloses a toner resin which is comprised of a polymer which is comprised of repeat units which are derived from (a) a vinyl aromatic monomer, (b) an acrylate monomer selected from the group consisting of alkyl acrylate monomers and alkyl methacrylate monomers, (c) acrylonitrile, wherein said polymer is void of repeat units which are derived from acrylic acid. This toner resin can be employed in manufacturing toners that exhibit a high level of rub-off resistance.

### BACKGROUND OF THE INVENTION

The development of electrostatic latent images with toner particles is well known. Over the years, the level of sophistication achieved in the field of electrostatic latent image development systems has been remarkable. For example, slow and laborious manual systems commercialized in the late 1950s have evolved into elegant high speed development systems creating as many as three copies per second. Consequently, the performance standards for toners during the evolution of electrostatography have become increasingly stringent. In the early manual development systems, toner and carrier particles were merely moved over an imaging surface bearing an electrostatic latent image by hand, tilting a tray containing the imaging surface and toner and carrier particles. However, in recent years, toner particles are automatically recycled many thousands of times over imaging surfaces moving at extremely high velocities. Thus, durable toner materials are required to withstand the physical punishment of vigorous, prolonged and continuous use. Moreover, toner particles deposited in image configuration must now be fused in extremely short periods of time.

Due to the size limitations of electrostatic copying and printing machines, the fusing path must be relatively short. When one attempts to increase the heat energy applied to deposited toner images for fusing purposes within the constraints of a limited fusing path to achieve adequate fixing at higher rates, one approaches the charring or kindling temperature of the substrate bearing the toner image. Attempts to shorten the fusing path by utilizing flash fusing techniques often result in the formation of noxious fumes due to decomposition of components in some toners. Further, the cost and availability of energy to operate an electrostatographic imaging system is of increasing concern to users. In addition, toner materials must possess the proper triboelectric charging properties for electrostatic latent image development and must not agglomerate during storage and transportation. Thus, there is a great need for an improved toner having stable electrical and physical properties which can endure the harsh environment of high speed electrostatographic copiers and printers and which can also be fused at lower temperatures utilizing less energy.

It is well known that electrostatic latent images can be developed with toner compositions that are comprised of a melt blend of toner resin and pigment particles. In such systems, negatively charged toner particles are generally selected for the development of positively charged electrostatic latent images. However, in recent years, the use of positively charged toner compositions containing charge enhancing additives for the purpose of imparting positive charge to toner resin particles has become more popular. These positively charged toner compositions are particularly useful for causing the development of negatively charged electrostatic latent images formed on layered organic photoreceptor imaging members. Examples of positively charged toner compositions useful for causing the development of negatively charged electrostatic latent images are disclosed in U.S. Pat. Nos. 4,298,672, 4,338,390 and 4,469,770.

Certain copolymers of styrene and butadiene have been developed which meet the demanding requirements of positively charged toner compositions. Such styrene-butadiene copolymers can be made by various techniques with emulsion polymerization being the most common. However, there are a number of traditional drawbacks associated with utilizing emulsion polymerization in preparing such toner resins which are utilized in preparing toners designed to build stable charge. For instance, undesirable residual contaminants are typically present in toner resins made by emulsion polymerization. In many cases, these residual contaminants have a very detrimental effect on the performance characteristics of the toner resin.

Rosin acids and fatty acids are commonly utilized as emulsifiers in preparing toner resins by emulsion polymerization. The presence of residual rosin acids and residual fatty acids in toner resins limits their ability to build stable electrical charges. The coagulants utilized in recovering the resin from the aqueous emulsion are also generally present as residual contaminants in such toner resins. The measurement of residual ash content of a resin (as measured by burning the resin) is an indicator of the total residual contaminants in the resin. The presence of such residual contaminants from the coagulants also limits the ability of toners made utilizing such resins to build a stable charge. For these reasons, emulsion polymerization has typically been considered to be inferior to solution polymerization and suspension polymerization techniques for synthesizing such toner resins.

U.S. Pat. No. 5,247,034 discloses the utilization of amino acid soaps in the synthesis of toner resins and circumvents some of the problems associated with utilizing rosin acid soaps or fatty acid soaps. By virtue of the fact that such emulsions can be coagulated without the utilization of salts, the resins made by the process disclosed in U.S. Pat. No. 5,247,034 exhibits low levels of residual contaminants. This is advantageous in that the presence of contaminants reduces the level of charge that can be realized. As a result of the low level of contaminants, the toner resin made utilizing the amino acid soap exhibits excellent resistance to moisture sensitivity and adsorption. This feature gives toners made from these resins better electrical charge stability compared to resins made from other soaps since adsorbed moisture is known to neutralize electrical charges. However, toners made with resins synthesized utilizing the technique of U.S. Pat. No. 5,247,034 have low adhesion characteristics to paper.

U.S. Pat. No. 5,852,151 discloses a process for preparing a polymer which is particularly useful as a toner resin, which comprises (1) emulsion copolymerizing a vinyl aromatic monomer and a second monomer selected from the group consisting of conjugated diene monomers and an acrylate monomer selected from the group consisting of alkyl acrylate monomers and alkyl methacrylate monomers in the presence of a diacid cycloaliphatic emulsifier to produce the polymer and (2) recovering the polymer from the aqueous emulsion. The toner resins made by the emulsion polymerization process described in U.S. Pat. No. 5,852,151 are capable of building very stable charges without compromising adhesion characteristics.

U.S. Pat. Nos. 5,683,848 and 5,804,349 disclose a process for the preparation of toner consisting essentially of: (i) preparing in the presence of an ionic surfactant and an optional nonionic surfactant a latex emulsion generated from the emulsion polymerization of a mixture of from about 55 to about 80 weight percent of styrene, from about 1 to about 25 weight percent of acrylate, from about 1 to about 20 weight percent of acrylonitrile, and from about 0.5 to about 5 weight percent of acrylic acid; (ii) mixing said latex emulsion by high shear blending with an aqueous pigment dispersion comprised of pigment and an ionic surfactant that is of opposite charge polarity to the ionic surfactant in said latex emulsion; (iii) heating the resultant flocculent mixture at a temperature that is about 30° C. below to about 10° above the glass transition temperature (Tg) of the latex resin to form electrostatically bound toner sized aggregates; (iv) subsequently heating said aggregate suspension at a temperature of from about 10° C. to about 50° C. above the glass transition temperature of the latex resin; and optionally (v) followed by washing, drying, and dry blending the toner with surface additives. The toner resins made by the process described in U.S. Pat. Nos. 5,683,848 and 5,804,349 are reported to provided simple and economical black and colored robust toner compositions which provide excellent image fix and gloss characteristics on different paper substrates. The toner resins described in U.S. Pat. Nos. 5,683,848 and 5,804,349 contain from about 55 to about 80 weight percent of styrene, from about 5 to about 25 weight percent of acrylate, from about 1 to about 20 weight percent of acrylonitrile, and from about 0.5 to about 5 weight percent of acrylic acid, and have a weight average molecular weight (Mw) of from about 18,000 to about 35,000 and a number average molecular weight (Mn) of from about 5,000 to about 10,000.

U.S. Pat. No. 5,910,387 discloses a toner composition comprised of colorant, and an addition polymer resin of styrene, butadiene, acrylonitrile and acrylic acid wherein said resin possesses a weight average molecular weight (Mw) of from about 15,000 to about 35,000 and a number average molecular weight (Mn) of from about 3,000 to about 12,000, relative to styrene standards.

### SUMMARY OF THE INVENTION

Rub-off, which is also known as back marking, occurs when a portion of the toner from a fused image sheet is transferred to the back of another sheet on top on the image sheet when the two sheets are rubbed together. The severity of rub-off is measured by digitizing the reflected light intensity over the affected image area and determining the distribution of luminosity. Small differences in rub-off can be best determined by measuring the standard deviation of this distribution curve. According to this method, a clean paper surface would have a rub-off value of <0.2. A rub-off value of 3 is considered to be acceptable quality and a value of 6 is considered to be a problem. A rub-off value of 9 is considered to be totally unacceptable.

This invention relates to toner resins that are synthesized by emulsion polymerization which exhibit good electrical charge stability, adhesion to paper, and rub-off characteristics. The toner resins of this invention are comprised of repeat units that are derived from a vinyl aromatic monomer, an acrylic monomer, and acrylonitrile. These resins are void of repeat units that are derived from acrylic acid. The toner resins of this invention also have a number average molecular weight of greater than 12,000, a weight average molecular weight of greater than 36,000, and a glass transition temperature which is within the range of about 45° C. to about 80° C. The toner resins of this invention are typically made by emulsion polymerization utilizing diacid cycloaliphatic emulsifiers to attain improved adhesion to paper, improved electrical charge stability, a high level of resistance to moisture, and resistance to moisture adsorption (adsorbed moisture is known to neutralize electrical charges).

In cases where a diacid cycloaliphatic emulsifier is utilized in synthesizing the toner resin some of the problems associated with utilizing rosin acid soaps or fatty acid soaps are eliminated. By virtue of the fact that such emulsions can be coagulated without the utilization of salts, the resins made by such a process exhibit low levels of residual contaminants. This is advantageous in that the presence of contaminants reduces the level of charge that can be realized. As a result of the low level of contaminants, the toner resin made utilizing the diacid cycloaliphatic emulsifiers exhibit excellent resistance to moisture sensitivity and adsorption. This feature gives toners made from these resins better electrical charge stability compared to resins made from standard soaps since adsorbed moisture is known to neutralize electrical charges.

Toners made with resins synthesized utilizing diacid cycloaliphatic also exhibit greatly improved adhesion to paper. This is highly desirable since it allows for printers and copiers to operate at a lower fusion temperature which results in energy savings. Better adhesion characteristics also normally allow for printers and copiers to be operated at greater speeds.

By utilizing the process of this invention, toner resins can be prepared which are of a very high quality. These toner resins can be utilized in making toners which are capable of building very stable charges without compromising adhesion characteristics and which have a high level of rub-off resistance.

This invention more specifically reveals a toner resin which is comprised of a polymer which is comprised of repeat units which are derived from (a) a vinyl aromatic monomer, (b) an acrylate monomer selected from the group consisting of alkyl acrylate monomers and alkyl methacrylate monomers, (c) acrylonitrile, wherein said polymer is void of repeat units which are derived from acrylic acid. These toner resins typically contain a residual amount of a diacid cycloaliphatic emulsifier, has a number average molecular weight of greater than 12,000, and have a weight average molecular weight of greater than 36,000.

The subject invention further discloses a toner which is comprised of (a) a polymer which is comprised of repeat units which are derived from (i) vinyl aromatic monomer, (ii) an acrylate monomer selected from the group consisting of alkyl acrylate monomers and alkyl methacrylate monomers, (iii) acrylonitrile, wherein said polymer is void of repeat units which are derived from acrylic acid (b) a residual amount of a diacid cycloaliphatic emulsifier and (c) a pigment.

The present invention also reveals a process for preparing a polymer which is particularly useful as a toner resin, which comprises (1) emulsion copolymerizing (a) a vinyl aromatic monomer, (b) an acrylate monomer selected from the group consisting of alkyl acrylate monomers and alkyl methacrylate monomers, and (c) acrylonitrile in the presence of a diacid cycloaliphatic emulsifier to produce the polymer; and (2) recovering the polymer from the aqueous emulsion.

### DETAILED DESCRIPTION OF THE INVENTION

The toner resins made by utilizing the process of this invention are comprised of repeat units which are derived from (a) a vinyl aromatic monomer, (b) an acrylate monomer selected from the group consisting of alkyl acrylate monomers and alkyl methacrylate monomers, and (c) acrylonitrile. A conjugated diolefin monomer, such as 1,3-butadiene or isoprene, can also optionally be included in the toner resin. In any case, these toner resins are made by the terpolymerization of the vinyl aromatic monomer, an acrylic monomer and acrylonitrile

Generally, any vinyl aromatic monomer that is known to polymerize in free radical systems can be used. Such vinyl aromatic monomers typically contain from 8 to 20 carbon atoms. Usually, the vinyl aromatic monomer will contain from 8 to 14 carbon atoms. Some representative examples of vinyl aromatic monomers that can be utilized include styrene, 1-vinyl napthalene, 2-vinyl napthalene, 3-methyl styrene, 4-propyl styrene, t-butyl styrene, 4-cyclohexyl styrene, 4-dodecyl styrene, 2-ethyl-4-benzyl styrene, 4-(phenylbutyl) styrene, divinylbenzene, and the like. Styrene is generally the most preferred vinyl aromatic monomer.

The alkyl acrylate monomers that can be used generally have the structural formula:

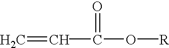

wherein R represents an alkyl group containing from 1 to 10 carbon atoms. The alkyl group in such alkyl acrylate monomers will preferably contain from 2 to 8 carbon atoms with alkyl groups which contain 4 carbon atoms being most preferred. Accordingly, ethyl acrylate, propyl acrylate, butyl acrylate, pentyl acrylate, hexyl acrylate and 2-ethyl hexyl acrylate are preferred alkyl acrylate monomers with butyl acrylate being the most preferred. The alkyl groups in such alkyl acrylate monomers can be straight chained or branched. Thus, normal-propyl acrylate, isopropyl acrylate, normal butyl acrylate or tertiary-butyl acrylate can be employed. Normal-butyl acrylate is a particularly preferred monomer.

The alkyl methacrylate monomers that can be used normally have alkyl groups which contain from 1 to about 20 carbon atoms. The alkyl methacrylate monomer will preferably have an alkyl group which contains from 2 to 12 carbon atoms. Some representative examples of alkyl methacrylate monomers which can be used include methyl methacrylate, butyl methacrylate, 2-ethylhexyl methacrylate, lauryl methacrylate, and the like.

The conjugated diene monomers that can optionally be used typically contain from 4 to about 10 carbon atoms. As a general rule, the conjugated diene monomer will contain from 4 to about 6 carbon atoms. Isoprene and 1,3-butadiene are highly preferred conjugated diene monomers for utilization in making toner resins by the process of this invention.

It is critical for the toner resins of this invention to contain at least about 15 weight percent acrylonitrile to attain the desired rub-off resistance. In most cases, the toner resin will contain from about 15 weight percent to about 30 weight percent acrylonitrile (repeat units that are derived from acrylonitrile). It is normally preferred for the toner resin to contain from about 17 weight percent to about 25 weight percent acrylonitrile. It is normally most preferred for the toner resin to contain from about 18 weight percent to about 22 weight percent acrylonitrile.

As the level of acrylonitrile in the polymer is increased it is also necessary to increase the level of the acrylate in the polymer to maintain the glass transition temperature of the polymer within the desired range. In any case, the toner resins of this invention will be derived from about 15 weight percent to about 30 weight percent of the acrylate monomer. It is typically preferred for the toner resins of this invention to contain from about 17 weight percent to about 25 weight percent of the acrylate monomer. It is typically more preferred for the toner resins of this invention to contain from about 18 weight percent to about 22 weight percent of the acrylate monomer.

The balance of the toner resin will be derived from vinyl aromatic monomers and, optionally, conjugated diolefin monomers. Accordingly, the total amount of vinyl aromatic monomers and conjugated diolefin monomers in the toner resin will typically be within the range of about 40 weight percent to about 70 weight percent. In cases where a conjugated diolefin monomer is employed it will typically be present at a level that is within the range of about 2 weight percent to about 20 weight percent. In cases where a conjugated diolefin monomer is employed it will more typically be present at a level that is within the range of about 5 weight percent to about 15 weight percent.

A typical toner resin is comprised of about 40 weight percent to about 70 weight percent styrene, about 15 weight percent to about 30 weight percent n-butyl acrylate, and about 15 weight percent to about 30 weight percent acrylonitrile. A preferred toner resin is comprised of about 50 weight percent to about 66 weight percent styrene, about 17 weight percent to about 25 weight percent n-butyl acrylate, and about 17 weight percent to about 25 weight percent acrylonitrile. A more preferred toner resin is comprised of about 56 weight percent to about 64 weight percent styrene, about 18 weight percent to about 22 weight percent n-butyl acrylate, and about 18 weight percent to about 22 weight percent acrylonitrile.

The toner resins of this invention typically have glass transition temperatures which are within the range of about 45□C. to about 80□C. It is normally preferred for the polymer to have a glass transition temperature which is within the range of about 55□C. to about 70□C. with it being most preferred for the polymer to have a glass transition temperature which is within the range of 60□C. to 65□C. As a general rule, higher levels of vinyl aromatic monomers result in higher glass transition temperatures. On the other hand, lower levels of vinyl aromatic monomers result in the polymer having lower glass transition temperatures. As a general rule, the glass transition temperature of the polymer should not be below about 40□C. because lower glass transition temperatures are indicative of polymers which are too soft for utilization in toner resin applications. The frangibility of toners is compromised if the glass transition temperature of the toner resin is above about 70□C.

Free radical emulsion polymerization techniques are utilized in conducting the process of this invention. Essentially any type of free radical generator can be used to initiate such free radical emulsion polymerizations. For example, free radical generating chemical compounds, ultra-violet light or radiation can be used. In order to ensure a satisfactory polymerization rate, uniformity and a controllable polymerization, free radical generating chemical agents are generally used. Some representative examples of free radical initiators which are commonly used include the various peroxygen compounds such as potassium persulfate, ammonium persulfate, benzoyl peroxide, hydrogen peroxide, di-t-butyl peroxide, dicumyl peroxide, 2,4-dichlorobenzoyl peroxide, decanoyl peroxide, lauryl peroxide, cumene hydroperoxide, p-menthane hydroperoxide, t-butyl hydroperoxide, acetyl acetone peroxide, dicetyl peroxydicarbonate, t-butyl peroxyacetate, t-butyl peroxymaleic acid, t-butyl peroxybenzoate, acetyl cyclohexyl sulfonyl peroxide, and the like; the various azo compounds such as 2-t-butylazo-2-cyanopropane, dimethyl azodiisobutyrate, azodiisobutyronitrile, 2-t-butylazo-1-cyanocyclohexane, 1-t-amylazo-1-cyanocyclohexane, and the like; the various alkyl perketals, such as 2,2-bis-(t-butylperoxy)butane, ethyl 3,3-bis(t-butylperoxy)butyrate, 1, 1-di- (t-butylperoxy) cyclohexane, and the like. Persulfate initiators, such as potassium persulfate and ammonium persulfate are especially useful in such aqueous emulsion polymerizations. Hydrogen peroxide is also a highly preferred free radical initiator which can be used in the process of this invention.

Generally from about 0.1 phm (parts per hundred parts of monomer) to about 1.0 phm of initiator will be utilized to initiate the copolymerization. In most cases, about 0.2 to about 0.7 phm of a free radical initiator will be utilized. Preferably, about 0.3 phm to about 0.5 phm of a free radical initiator will be employed.

To reduce the molecular weight of the polymer, the emulsion polymerization can be conducted in the presence of one or more chain transfer agents. The chain transfer agent will typically be employed at a level which is within the range of 0.005 phm to about 6 phm. Alkyl mercaptans are particularly preferred for utilization as the chain transfer agent. Tertiary-dodecylmercaptan and normal-dodecylmercaptan are highly preferred with normal-dodecylmercaptan being the most highly preferred. Mercaptans having lower molecular weight alkyl groups cause dramatic reductions in molecular weight. However, the use of such low molecular weight mercaptans results in odor problems. For instance, toners made with resins prepared utilizing such low molecular weight mercaptans can give off very unpleasant odors when the toner resin is ultimately used in a copier. Higher molecular weight mercaptans typically do not cause odor problems. However, they are not very effective at reducing the molecular weight of the polymer being prepared by free radical emulsion polymerization. It is typically advantageous for the chain transfer agent to be added incrementally throughout the polymerization.

A wide variety of emulsifiers can be used in synthesizing the toner resin by emulsion polymerization. For instance, rosin acids and fatty acids can be used as the emulsifier in preparing the toner resins. However, the terpolymerizations of this invention are preferably carried out in the presence of a diacid cycloaliphatic emulsifier. These diacid cycloaliphatic soaps are typically cycloalkenes and cycloalkanes containing a carboxyl group and a fatty acid group bonded thereto, wherein the fatty acid group contains from 1 to about 25 carbon atoms. It is normally preferred for the diacid cycloaliphatic emulsifier to be of the structural formula:

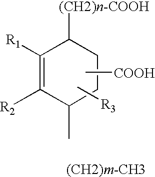

wherein n is an integer from 1 to about 35, wherein m is an integer from 0 to 25 and wherein R1, R2 and R3 are selected from the group consisting of hydrogen atoms and alkyl groups containing from 1 to about 25 carbon atoms. Carboxy-4-hexyl-2-cyclohexene-1-octanoic acid which has the structural formula:

[chemical structure]

is a highly preferred diacid cycloaliphatic emulsifier.

The diacid cycloaliphatic emulsifier can also be a cyclohexane which is of the structural formula:

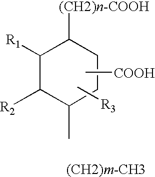

wherein n is an integer from 1 to about 35, wherein m is an integer from 0 to 25 and wherein R1, R2 and R3 are selected from the group consisting of hydrogen atoms and alkyl groups containing from 1 to about 25 carbon atoms.

The diacid cycloaliphatic emulsifier employed can also be in the form of a salt. Salts can be readily formed by reacting the diacid cycloaliphatic emulsifier with an appropriate base, such as sodium hydroxide, potassium hydroxide, ammonium hydroxide, monoethanol amine, diethanol amine or triethanol amine. As a general rule, sodium salts are preferred.

Generally, from about 0.5 phm to about 6 phm of the diacid cycloaliphatic emulsifier is utilized in preparing the aqueous polymerization medium. The use of less than about 0.5 phm of the diacid cycloaliphatic soap leads to latex instability. On the other hand, the utilization of more than about 6 phm of the diacid cycloaliphatic emulsifier causes isolation problems. In most cases, it will be preferred to utilize from 1 phm to 3 phm of the diacid cycloaliphatic soap. The precise amount of diacid cycloaliphatic emulsifier required in order to attain optimal results will, of course, vary with the monomers being polymerized. However, persons skilled in the art will be able to easily ascertain the specific amount of emulsifier required in order to attain optimal results. In some cases, it may be beneficial to add the diacid cycloaliphatic emulsifier incrementally as the polymerization proceeds.

The free radical emulsion polymerization will typically be conducted at a temperature that is within the range of about 100□F. (39□C.) to about 200□F. (93□C.). It is generally preferred for the polymerization to be carried out at a temperature which is within the range of 115□F. (46□C.) to about 175□F. (74□C.). To increase conversion levels, it is typically advantageous to increase the temperature as the polymerization proceeds. For instance, the polymerization temperature could be maintained at about 125□F. (52□C.) at the beginning of the polymerization and increased to a final temperature of about 175□F. (74□C.) at the end of the polymerization.

The polymerization time required in order to carry out such free radical emulsion polymerization generally ranges between about 3 hours and about 12 hours. In most cases, the polymerization reaction can be completed in about 4 to about 8 hours. The polymerization can be carried out as a batch process. However, it is generally advantageous to utilize a semi-continuous process wherein the monomers are charged over a period of about 2 to about 6 hours. It is typically most preferred to charge the monomers over a period of about 3 hours to about 5 hours.

After the polymerization has been completed, the toner resin can be recovered from the emulsion by coagulation. Divalent salts, such as calcium salts, magnesium salts, barium salts, zinc salts, and the like can be used in the coagulation. Trivalent salts, such as aluminum salts, are generally better. The latex can be coagulated with alum (aluminum potassium sulfate) or an acid such as sulfuric acid, hydrochloric acid, nitric acid or acetic acid. It is highly preferred to coagulate the latex with sulfuric acid. It is not necessary to utilize salts or amines in such coagulation procedures. In fact, it is highly preferred to carry out the coagulation in the absence of salts or amines. This is because residual amounts of such compounds are detrimental to the ultimate properties of the toner resin. Hydrochloric acid can be used but is generally not preferred because it is too corrosive and can give off HCl gas. Nitric acid is also too corrosive and can give off nitrous oxide. The utilization of acetic acid can result in odor problems. For these reasons, sulfuric acid is highly preferred for utilization in carrying out the coagulation.

The cake of resin recovered by coagulation is then typically filtered and washed with water. It is then capable of being dewatered by the process described in U.S. Pat. No. 2,615,206, known as syneresis. The teachings of U.S. Pat. No. 2,615,206 are incorporated herein by reference in their entirety. It is highly advantageous that the resins made by the process of this invention are capable of undergoing such a dewatering process. In this syneresis process, the cake of resin is simply heated to an elevated temperature which shrinks (contracts) the cake of resin thereby squeezing the water out of it. This syneresis process typically reduces the water content of the resin from about 70 percent to about 30 percent. The resin can then be further dried on an apron dryer.

Toners can be made with the toner resins of this invention utilizing standard procedures. Such toner resins will be comprised of the toner resin and at least one pigment, such as carbon black or iron oxide. In cases where carbon black is employed as the pigment, it will normally be present in the toner composition in an amount which is within the range of about 2 weight percent to about 10 weight percent. It is typically preferred for carbon black to be present in an amount that is within the range of about 5 weight percent to about 7 weight percent. In cases where iron oxide is employed as the pigment, it will normally be present in the toner composition in an amount which is within the range of about 10 weight percent to about 60 weight percent.

The toner composition can optionally contain a charge control agent and/or a wax. In cases where a charge control agent is used, it will normally be present in an amount which is within the range of about 0.5 weight percent to about 3 weight percent. In cases where a wax is included in the toner, it will typically be present in an amount which is within the range of about 1 weight percent to about 10 weight percent.

This invention is illustrated by the following examples which are merely for the purpose of illustration and are not to be regarded as limiting the scope of the invention or the manner in which it can be practiced. Unless specifically indicated otherwise, all parts and percentages are given by weight.

### EXAMPLE 1

In this experiment, a toner resin was synthesized utilizing the emulsion copolymerization technique of this invention. In the procedure utilized, 17,490 grams of water, 3180 grams of a 10 percent aqueous solution of Diacid® 1550 carboxy-4-hexyl-2-cyclohexene-1-octanoic acid emulsifier, 31.8 grams of sodium hydroxide, 63.6 grams of sodium sulfate, 1.3 grams of t-docecyl mercaptan (a chain transfer agent) and 55.65 grams of ammonium persulfate were charged into a 10-gallon (37.85 liter) reactor. Then the monomers were continuously charged into the reactor over a period of 4 hours at a rate of 8.9 pounds (4.0 kg) per hour. During this 4-hour period, 9540 grams of styrene, 3180 grams of n-butylacrylate, 3180 grams of acrylonitrile, and 159 grams of t-dodecyl mercaptan were charged into the polymerization reactor as aqueous solutions. The monomer charge contained 60 weight percent styrene, 20 weight percent n-butylacrylate, and 20 weight percent acrylonitrile.

The polymerization temperature was maintained at about 125□F. (52□C.) with the solids content of the latex produced being monitored. After about 5 hours of polymerization time, when a solids content of about 40 percent was attained, the polymerization temperature was increased to about 172□F. (78□C.) and the polymerization was continued for an additional 3 hours. A final solids content of about 45 percent was attained after the fill 8 hours of polymerization time.

The latex was then coagulated by pouring 5.5 pounds (2.5 kg) of it into 25 pounds (11 kg) of water which contained 25 grams of sulfuric acid at a temperature of 150□F. (66□C.). The resin was filtered out of the water, washed two times, and dried at a temperature of 140□F. (60□C.) to a final moisture content of about 0.1 percent. The resin recovered in this experiment weighed 2.36 pounds (1 kg).

### EXAMPLE 2

In this experiment, a toner was made utilizing the toner resin synthesized in Example 1. The toner was made by melt-mixing in an extruder 92 parts of the resin synthesized in Example 1 with 6 parts of Regal® 330 carbon black from Cabot Corporation and 2 parts of Arosurf® TA-101 1-octadecanaminium, N,N,-dimethyl-N-octadecyl-chloride charge control agent from Witco Corporation. The mixture was cooled, mechanically ground to about 1 mm granules and then pulverized on a jet mill to a medium volume particle size of about 10 microns to provide the toner.

The rub-off properties of the toner was quantitatively determined by rubbing a compressed pellet formed from the toner against a paper surface and measuring the optical density of the mark produced by toner transferred to the paper. The pellet was prepared by placing a 0.5 gram sample of the toner into a die having a diameter of 1 cm under a 5000 pound load for at least one minute at ambient temperature (about 20□C.). The pellet was then rubbed against the paper surface under a load of 1.9 kg to produce an image streak.

The rub-off characteristics of the images was then determined by digitizing the reflected light intensity over the affected image area and determining the distribution of luminosity. The rub-off value of the image was determined to be 3.3 which is considered to be acceptable.

### COMPARATIVE EXAMPLES 3-5

In this series of experiments, styrene/n-butyl acrylate/acrylonitrile toner resins were synthesized utilizing the same general procedure as was employed in Example 1. However, the monomer charge compositions were adjusted to synthesize resins having the compositions shown in Table I. These resins were then employed in making toners using the procedure described in Example 2. The toners were then evaluated to determine their rub-off resistance and the results of this evaluation are also reported in Table I:

TABLE I

| Ex | Styrene | Butyl Acrylate | Acrylonitrile | Rub-off |
|---|---|---|---|---|
| 2 | 60% | 20% | 20% | 3.3 |
| 3 | 75% | 25% | 0% | 11.7 |
| 4 | 70% | 24% | 6% | 7.4 |
| 5 | 70% | 20% | 10% | 5.8 |

The toner resin made in accordance with this invention (Example 2) had a rub-off value of 3.3. A rub-off value of 3 is considered to be acceptable quality. However, a rub-off value of about 6 is considered to be a problem. Thus, the toner resins made in Comparative Examples 4 and 5 not be considered to be very good from the standpoint of their rub-off characteristics. A rub-off value of greater than 9 is considered to be totally unacceptable. Thus, the toner made in Comparative Example 3 was considered to be a total failure from the standpoint of its rub-off characteristics.

While certain representative embodiments and details have been shown for the purpose of illustrating the subject invention, it will be apparent to those skilled in this art that various changes and modifications can be made therein without departing from the scope of the subject invention.

What is claimed is:

1. A toner resin which is comprised of a polymer which is comprised of repeat units which are derived from (a) a vinyl aromatic monomer, (b) an acrylate monomer selected from the group consisting of alkyl acrylate monomers and alkyl methacrylate monomers, (c) acrylonitrile, wherein said polymer is void of repeat units which are derived from acrylic acid.

2. A toner resin as specified in claim 1 which is further comprised of a residual amount of a diacid cycloaliphatic emulsifier.

3. A toner resin as specified in claim 1 wherein said polymer has a number average molecular weight of greater than 12,000.

4. A toner resin as specified in claim 1 wherein said polymer has a weight average molecular weight of greater than 36,000.

5. A toner resin as specified in claim 1 wherein the polymer is comprised of repeat units which are derived from 15 weight percent to about 30 weight percent acrylonitrile.

6. A toner resin as specified in claim 5 wherein the polymer is comprised of repeat units which are derived from 15 weight percent to about 30 weight percent of the acrylate monomer.

7. A toner resin as specified in claim 6 wherein the acrylate monomer is an alkyl acrylate monomer.

8. A toner resin as specified in claim 7 wherein the vinyl aromatic monomer is styrene.

9. A toner resin as specified in claim 8 wherein the alkyl acrylate monomer is n-butyl acrylate.

10. A toner resin as specified in claim 9 wherein the polymer has a glass transition temperature which is within the range of about 45° C. to about 80° C.

11. A toner resin as specified in claim 10 which is further comprised of a residual amount of a diacid cycloaliphatic emulsifier.

12. A toner resin as specified in claim 11 wherein said polymer has a number average molecular weight of greater than 14,000.

13. A toner resin as specified in claim 12 wherein said polymer has a weight average molecular weight of greater than 38,000.

14. A toner resin as specified in claim 13 wherein the polymer is comprised of repeat units which are derived from 17 weight percent to about 25 weight percent acrylonitrile.

15. A toner resin as specified in claim 14 wherein the polymer is comprised of repeat units which are derived from 17 weight percent to about 25 weight percent of the n-butyl acrylate monomer.

16. A toner resin as specified in claim 15 wherein the polymer has a glass transition temperature which is within the range of about 55° C. to about 70° C.

17. A toner which is comprised of (a) a polymer which is comprised of repeat units which are derived from (i) vinyl aromatic monomer, (ii) an acrylate monomer selected from the group consisting of alkyl acrylate monomers and alkyl methacrylate monomers, (iii) acrylonitrile, wherein said polymer is void of repeat units which are derived from acrylic acid (b) a residual amount of a diacid cycloaliphatic emulsifier and (c) a pigment.

18. A toner as specified in claim 17 which is further comprised of a charge control agent.

19. A toner as specified in claim 18 which is further comprised of a wax.

20. A process for preparing a polymer which is particularly useful as a toner resin, which comprises (1) emulsion copolymerizing (a) a vinyl aromatic monomer, (b) an acrylate monomer selected from the group consisting of alkyl acrylate monomers and alkyl methacrylate monomers, and (c) acrylonitrile in the presence of about 0.5 phm to about 6 phm of a diacid cycloaliphatic emulsifier to produce the polymer; and (2) recovering the polymer from the aqueous emulsion.
